(19) United States
(12) Patent Application Publication
(10) Pub. No.: US 2006/0105297 A1
(43) Pub. Date: May 18, 2006

(54) Vapor deposited multilayer dental devices

(75) Inventors: Kenneth E. Knapp, Livermore, CA (US); Michael L. Hedrick, Livermore, CA (US); Brett S. Wells, Morgan Hill, CA (US)

Correspondence Address: MARK A LAUER, 6601 KOLL CENTER PARKWAY, SUITE 245, PLEASANTON, CA, 94566, US

(73) Assignee: Nano-Write Corporation

(21) Appl. No.: 11/320,116

(22) Filed: Dec. 27, 2005

Related U.S. Application Data
(63) Continuation-in-part of application No. 10/622,626, filed on Jul. 17, 2003, now Pat. No. 6,994,550.
(60) Provisional application No. 60/436,177, filed on Dec. 23, 2002.
(60) Provisional application No. 60/710,529, filed on Aug. 22, 2005.

(51) Int. Cl. A61C 13/08

(52) U.S. Cl. 433/206

(57) ABSTRACT

Dental devices such as crowns, bridges and implants are disclosed, such devices comprising a self-supporting structural layer, a ceramic outer layer attached to the structural layer, and a porcelain layer attached to the ceramic layer, the ceramic outer layer made of a nitride, oxide or oxynitride of titanium (Ti) or zirconium (Zr). The devices are biocompatible and can have thin layers that are exactingly tailored. In one embodiment, a gold layer is disposed between the ceramic outer layer and the porcelain layer. In one embodiment, the gold layer comprises a nanocomposite of gold and oxides, nitrides or oxynitrides of indium, tin or zinc. In one embodiment, the structural layer is made of a cobalt alloy having a coefficient of expansion that substantially matches that of the porcelain layer. Methods for making and using such devices are also disclosed, including vapor deposition of metal and/or ceramic layers.

### CROSS-REFERENCE TO RELATED APPLICATIONS

The present application claims the benefit under 35 U.S.C. §120 of (is a continuation-in-part of) application Ser. No. 10/622,626, filed Jul. 17, 2003, which claims the benefit under 35 U.S.C. §119 of Provisional Application Ser. No. 60/436,177, filed Dec. 23, 2002. The present application also claims the benefit under 35 U.S.C. §119 of Provisional Application Ser. No. 60/710,529, filed Aug. 22, 2005. All of the above-referenced applications are incorporated by reference herein.

### BACKGROUND

The present application relates to biomedical devices, such as dental crowns, bridges and implants, and other devices that can be employed within people or animals.

The manufacture of dental devices such as crowns has traditionally been a labor-intensive process. After a dentist has ground away parts of a patient's tooth to leave a protruding tooth stub, an impression of the stub is taken, typically along with an impression of the surrounding and opposing teeth. The impression is typically sent to a dental laboratory, which makes a mold from the impression of the stub, the mold commonly made of gypsum and called a die stone. For crowns that are made completely of metal such as gold, silver, palladium or stainless steel, a wax replica of the tooth is then hand crafted on the die stone, and the wax tooth replica is then invested in a material that solidifies. As that material is heated the wax is melted or burned out. The molten metal is then poured into a void created by the lost wax, and cools to become the crown.

Conventional fabrication of porcelain crowns is complicated by attempting to match the crown to the color of the surrounding teeth. In this case, the crown is usually formed atop a metal coping that may impart a color that is apparent through translucent porcelain. For instance, a titanium (Ti) coping readily oxidizes to have a titanium oxide (TiO or TiO₂) film, which is black and can affect the color of the porcelain crown.

Such a metal coping is usually made by the lost wax technique to fit atop the tooth stub. Lost wax casting of titanium requires specialized vacuum casting equipment not typically used for noble and base metal alloys, to avoid denegrating the titanium. On the other hand, metal copings made of noble metals such as gold (Au), silver (Ag) and/or palladium (Pd) or base metals such as nickel (Ni) or beryllium (Be) can cause allergic reactions. After casting, the cast metal coping is hand finished to a thickness as small as 0.2 millimeters (mm). Such hand working is difficult and can result in holes in the coping that require the coping to be recast.

Prior to applying porcelain to the coping, the mandrel is removed. Titanium copings usually have a covering of opaque porcelain baked on the coping to hide the TiO/TiO₂ film. The baked-on porcelain also helps to bond the porcelain veneer to the titanium coping. The translucent porcelain layers are then applied atop the baked porcelain layer and fired. After the porcelain has been fired and machined to finish the crown, the metal and porcelain crown are bonded to the tooth stub.

Recently, instead of forming a crown or coping with the lost wax technique, a computer aided design/computer aided engineering (CAD/CAM) process has been developed to shape copings for porcelain crowns. The machinery for this is fairly expensive, however, and the coloring of the coping can still affect the crown color. Moreover, pressure from the automated tools that shape the coping becomes problematic at a coping thickness of a few tenths of a millimeter.

### SUMMARY

In one embodiment, a dental device is disclosed comprising a metal-ceramic laminate including a metallic structural layer that provides most of the strength of the laminate and a ceramic outer layer having a thickness that is less than that of the structural layer, the ceramic outer layer made of a nitride, oxide or oxynitride of titanium or zirconium, and a porcelain layer attached to the ceramic outer layer, the porcelain layer having a thickness that is greater than the ceramic outer layer thickness. The dental device may further include a gold layer disposed between the ceramic layer and the porcelain layer. In another embodiment, the dental device comprises a structural layer made of a cobalt alloy having a first coefficient of expansion, a ceramic outer layer attached to the structural layer, and a porcelain layer having a second coefficient of expansion, wherein the first coefficient of expansion substantially matches the second coefficient of expansion. In another embodiment, the dental device comprises a self-supporting substrate, a ceramic outer layer attached to the self-supporting substrate, a gold layer attached to the ceramic outer layer, and a porcelain layer attached to the gold layer. In one embodiment, the gold layer comprises a nanocomposite of gold and oxides, nitrides or oxynitrides of indium, tin or zinc.

Methods for making and using a dental device are also disclosed, including vapor deposition of metal and/or ceramic layers. In one embodiment, the method includes forming a first vapor that solidifies to form a metallic structural layer, forming a second vapor that solidifies to form a ceramic outer layer, and attaching a porcelain layer atop the ceramic outer layer. In one embodiment, the method includes applying a gold layer over the ceramic outer layer prior to forming the porcelain layer. In one embodiment, applying the gold layer comprises forming a third vapor that solidifies to form a nanocomposite of gold and oxides, nitrides or oxynitrides of indium, tin or zinc.

### BRIEF DESCRIPTION OF THE DRAWINGS

FIG. 1 is a cross-sectional view of a person's tooth, including a prosthetic crown.

FIG. 2 is a cross-sectional view of a mandrel upon which a coping of the crown was formed.

FIG. 3 is a schematic diagram of a physical vapor deposition system in which a coping or other biomedical device may be formed.

FIG. 4 is a cross-sectional view of a mandrel including a tooth mold upon which a three-layer coping has been formed.

FIG. 5 is a cross-sectional view of a crown for a tooth, the crown including a porcelain layer bonded to the coping of FIG. 4.

FIG. 6 is a cross-sectional view of a portion of the tooth mold of FIG. 4 with a plurality of attached protrusions that affect the texture of the coping.

FIG. 7 is a cross-sectional view of a crown for a tooth, the crown including a porcelain layer and an optional gold layer over a laminated coping.

### DETAILED DESCRIPTION

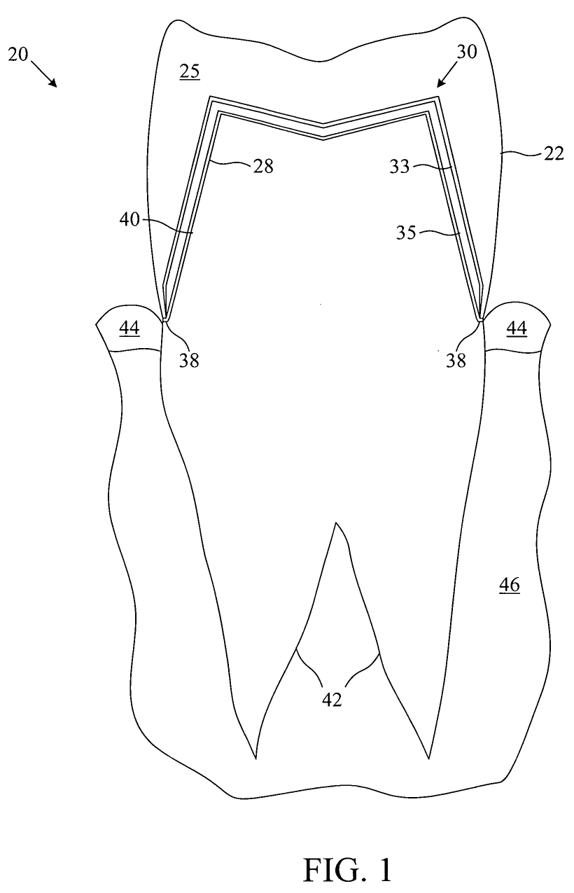

A cross-sectional view of a person's tooth 20 is shown in FIG. 1. The tooth 20 has a crown 22 including a porcelain layer 25 that is attached to a metal coping 30. The coping 30 includes a titanium-nitride (TiN) layer 33 disposed on a titanium (Ti) layer 35. In another embodiment, the coping may also include an inner layer of TiN upon which Ti layer 35 is disposed. The coping 30 is bonded with a cement layer 28 to a stub 40 of the tooth 20, the stub having been machined by a dentist to prepare for attachment of the crown 22. The machining was terminated at a lip near a top of the gums 44, the cement bonding the coping and porcelain to the lip in a margin region 38. Also shown are roots 42 of the tooth 20 that extend through a jaw bone 46.

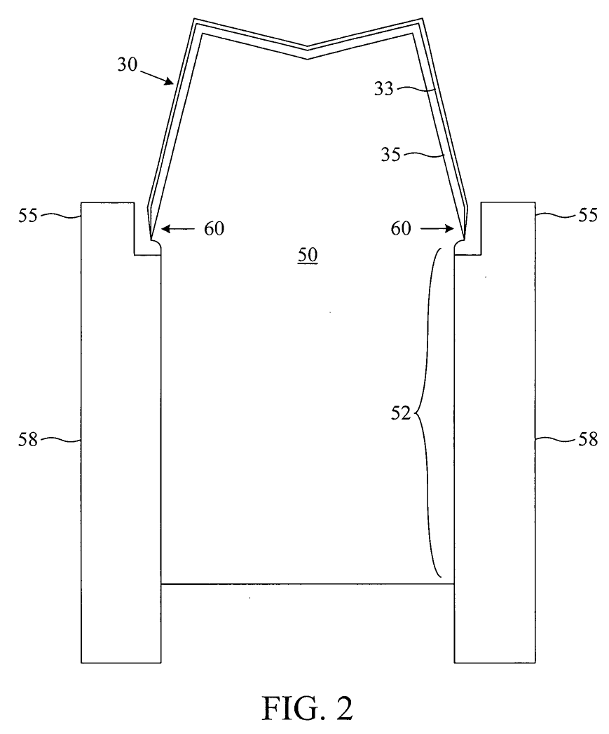

FIG. 2 is a cross-sectional view of a mandrel 50 upon which coping 30 has been formed. The mandrel 50 may for example be a die stone that has been formed from an impression of the tooth stub 40, not shown in this figure. The coping has been formed by physical vapor deposition (PVD), such as cathodic arc deposition, sputtering, ion beam deposition, molecular beam deposition, etc. The mandrel in this embodiment has a handle portion 52 that is slightly recessed compared to the tooth stub portion upon which the coping is formed. In other embodiments the handle portion may not be recessed but may instead be even with or wider than the tooth stub portion. The handle portion is held by clamps 58 which each have a projection 55 that extends adjacent the coping beyond the handle region. The projections 55 provide a shadow during PVD that tapers and terminates ends 60 of the coping 30.

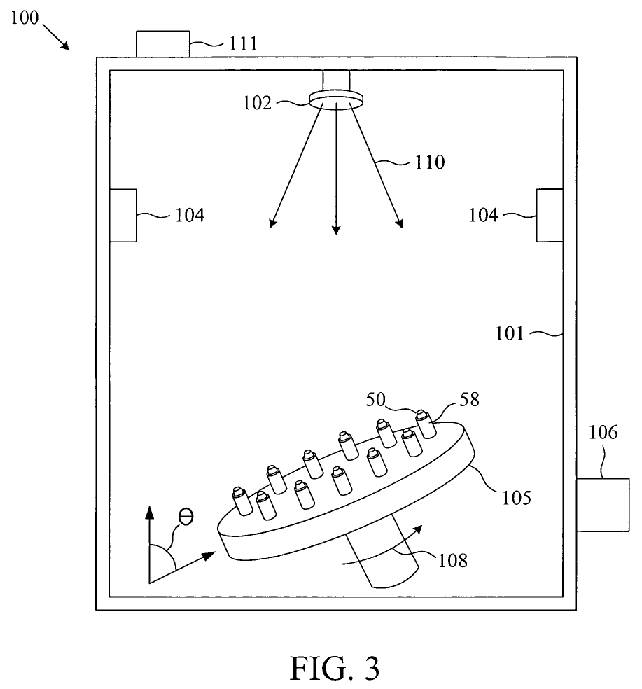

FIG. 3 shows a physical vapor deposition system 100 in which a coping or other biomedical device may be formed. The system 100 has a chamber 101 that may be evacuated by vacuum pump 106 to a pressure of 10⁻⁴ Torr or below. Within chamber 101 a moveable platter or pallet 105 holds mandrel 50 as well as a plurality of other mandrels, for receiving material from a target 102 such as a metal cathode. Platter 105 can rotate, as shown by arrow 108, and can tilt to various angles θ from normal to the direction of physical vapor flow from target 102.

Anode or anodes 104 are disposed near cathode 102, which may be made of titanium, zirconium, hafnium or other selected metals. An arc is created between the anode 104 and cathode 102 that generates metal ions as well as some macroparticles at the cathode, the ions and macroparticles traveling generally toward the tilted, rotating platter 105 as shown by arrows 110. Application of a magnetic field and a curved path, not shown in this embodiment, can be used to filter out the macroparticles so that a reduced proportion of macroparticles impinge upon mandrel 50. In another embodiment, system 100 can be a sputtering system or ion beam deposition system. Combination of various physical vapor deposition systems can also be used to deposit various materials on mandrel 50 and the other mandrels on moveable platter 105.

Addition of a gas such as nitrogen via gas inlet 111 can cause formation of a ceramic such as TiN on mandrel 50. In this manner a three-dimensional thin-shelled atomic vapor or molten droplet deposited biomedical prosthetic device can be formed of various metals and ceramics. One embodiment described in this application is a restorative dental crown coping device. Once the coping has been formed on mandrel 50, for example with a layer of Ti and a layer of TiN as shown in FIG. 2, the mandrel can be removed from the coping and porcelain applied to the coping.

Alternatively, mandrel 50 material can be removed after a porcelain layer or layers have been formed on the coping. This can be particularly advantageous for the situation in which a very thin coping 30 is desired, e.g., a coping thickness less than 0.2 mm. In this case, stress from the porcelain as it hardens could alter the coping shape. In the prior art this problem has not been encountered because such a thin coping could not be produced. After the porcelain has been sintered the mandrel material is removed by grinding and optional etching. In this situation it is desirable to use an etchant that does not react with porcelain. It is also possible to use a mandrel material that does not harden when the porcelain is fired.

In contrast with conventional porcelain crowns, the step of applying and firing an initial layer of opaque porcelain is not necessary. This is because the porcelain bonds to the TiN layer and so the baked on layer is not needed for strength. This is also because the TiN layer is a golden color that is close to the color of natural dentin, instead of the black color of titanium oxide or the silver color of other metals, and so the baked-on opaque porcelain layer is not needed for aesthetics. Applying and firing an initial opaque layer of porcelain to the coping 30 is therefore optional. It is also possible to provide an additional bonding layer of porcelain.

The mandrel 50 or die stone can be removed by grinding and/or etching, to yield a coping formed entirely by PVD. While the coping 30 is held with special tweezers, translucent porcelain is then applied to the coping in the shape of the tooth. After glazing or firing the porcelain at a high temperature the porcelain finish can be ground and polished to replicate the shape of a natural tooth, yielding the porcelain-on-metal crown 22. The crown can be bonded to the tooth stub 40 with cement 28, restoring the functioning of the tooth 20.

A number of advantages are provided by this dental restoration system. One of the benefits is a reduced cement thickness variation, due to the more accurate fit of the dental crown coping to the die stone or mandrel made by physical vapor deposition compared to the fit of a coping made by the lost wax technique. Another benefit of the replication process is the improved margin region 38 fit between the coping layers and the tooth dentin and enamel, again due to the improved accuracy of PVD compared to lost wax formation. The improved margin fit may be in a range between about 0.1 microns (μm) and 5.0 μm. The nominal cement layer 28 thickness may be in a range between about 5 μm and 50 μm.

An additional benefit is the ability to precisely control the thickness and properties of plural coping layers. For example, an inner layer that interfaces with the tooth via the cement may be formed of TiO or TiN, a structural layer that provides most of the strength of coping structure may be formed of Ti and an outer layer that bonds with dental porcelain is formed in this embodiment of TiN. The plural layers have material properties and thickness than are independently and precisely controlled with the deposition process and materials selection, as discussed below. The combined thickness of the vapor-deposited layers making up the dental crown coping are typically 0.05 millimeters (mm) to 3.0 mm with a thickness tolerance typically ranging from less than 1 μm to about 0.05 mm. Due to the reduced and more accurate thickness of both the coping and the cement, the amount of tooth that is removed in preparation for a dental crown restoration is typically reduced by as much as a few millimeters compared to conventional porcelain crowns.

The angle θ at which the physical vapor is deposited with respect to substrate normal ranges between about 5° and 75° full width half maximum (FWHM). A preferred FWHM of deposited vapor is about 45° while platter 105 is rotating to deposit sufficient thickness of metal and/or ceramic layers on all sides of mandrel 50 shown in FIG. 3. Thermal, electron beam and laser beam evaporation or thermal spraying methods, such as flame spraying or plasma arc spraying may be used. Cathodic arc deposition may be a preferred method due to its high deposition rate, which may range between about 0.1 μm/min and 20 μm/min, and the large fraction of energetic atomic vapor species to droplet species in the deposition vapor stream between the deposition source and dental mandrel. It has been discovered that a deposited ratio of (atomic vapor)/(molten droplets) greater than about 0.5 results in favorable metal and ceramic layers. This ratio can be significantly higher than 0.5, such as greater than 1.0 when the macroparticles are filtered out as described above.

The deposited layers can be single inorganic layers or multiple (e.g., up to 1000) layers. The layers can include inorganic metals, nitrides, carbides and oxides. Typical metals used for PVD of the layers include titanium, zirconium, molybdenum, tungsten, tantalum, niobium, vanadium, chromium, nickel, iron, copper, beryllium, ruthenium, rhodium, platinum, palladium, hafnium, silicon, aluminum, gold, silver, cobalt and their alloys. Nitrides and carbides of titanium, zirconium, molybdenum, tungsten, tantalum, niobium, vanadium, platinum, palladium, hafnium, silicon, aluminum, silver, indium, zinc and tin can be formed for the coping or other biomedical layers. Oxides of titanium, zirconium, molybdenum, tungsten, tantalum, niobium, vanadium, chromium, nickel, iron, copper, ruthenium, rhodium, platinum, palladium, hafnium, silicon, aluminum, silver, indium, zinc, and tin may also be used.

The layers can also include metals doped with about 0.1 to 2 atomic percent oxygen or nitrogen. The metals which may be doped include titanium, zirconium, molybdenum, tungsten, tantalum, niobium, vanadium, chromium, nickel, hafnium, aluminum, cobalt and alloys of these metals. These doped metals differ in properties from metal oxides or nitrides, which may include roughly stoichiometric ratios of elements.

For metals such as titanium and zirconium, doping can stabilize the crystalline phase of the material. At high temperature the crystalline phase of a metal can change; doping may increase the temperature at which the phase change occurs, thereby stabilizing the crystalline phase. A change in the crystalline phase of a material can result in a change in volume of the material, which may be undesirable. Prevention of temperature-induced volume changes may be useful in a coping 30 of a dental device such as that shown in FIG. 1. A coping 30 may be exposed to very high temperatures if a technique such as a “press-to-metal” technique is used to apply the porcelain layer 25, and a coping 30 that includes doped metals is better able to withstand those high temperatures. In general, the crystalline phase of doped metals used for self-supporting substrates are preferably stable between 20 and 1200 degrees centigrade

Typical deposited layer thickness for biomedical embodiments range from 10 Å to 5 mm depending on the intended application. Titanium and its nitrides, oxides and carbides can be advantageous because of the known biocompatibility of these materials with mammals. Instead of a coating a substrate that is removed, a coating can be formed on a device that is not removed, such as a Ti wire coated with TiN. Alternative organic materials, such as polyimide, polyester and teflon can be used as single layers or combined with inorganic materials as described previously. Typically organic layer thickness range from 1000 Å to 5 mm in thickness.

Cobalt and cobalt alloys can be advantageous for biomedical embodiments because certain cobalt alloys are known to have high strength and to be biocompatible with mammals. One preferred alloy is cobalt chromium molybdenum (CoCrMo), in which chromium and molybdenum are at least partially oxydized. CoCrMo can be advantageous for dental devices because its coefficient of expansion can be substantially matched (e.g., within five percent) to that of dental porcelains commonly used. Although not generally biocompatible, nickel may be used as a substitute for cobalt in some alloys. In this case, a self-supporting substrate for a dental device can be formed, for example by PVD of a cobalt and/or nickel alloy, in which the overall atomic concentration of cobalt and nickel can be up to sixty-five percent, the atomic concentration of chromium can range between ten and fifty percent, the atomic concentration of molybdenum can range between zero and twenty percent, optional traces of aluminum (Al) and/or silicon (Si) of up to five atomic percent can be included.

Gold alloys are commonly used for dental devices. Pure gold is known to be biocompatible with mammals, but pure gold is not strong, so it is typically used in alloys containing significant fractions of other metals. Some embodiments of the present invention include a gold layer underlying the porcelain layer 25 of a dental device such as that shown in FIG. 1. The gold layer can be applied over a laminated coping 30 that includes a metallic structural layer and a ceramic outer layer. In one embodiment, the gold layer includes a nanocomposite of gold and oxides, nitrides or oxynitrides of indium, tin or zinc. Gold comprises the majority of the nanocomposite; gold provides biocompatibility and a color that is aesthetically satisfactory beneath the porcelain layer 25. The minor constituent metals of the nanocomposite form oxides or nitrides that bond to porcelain.

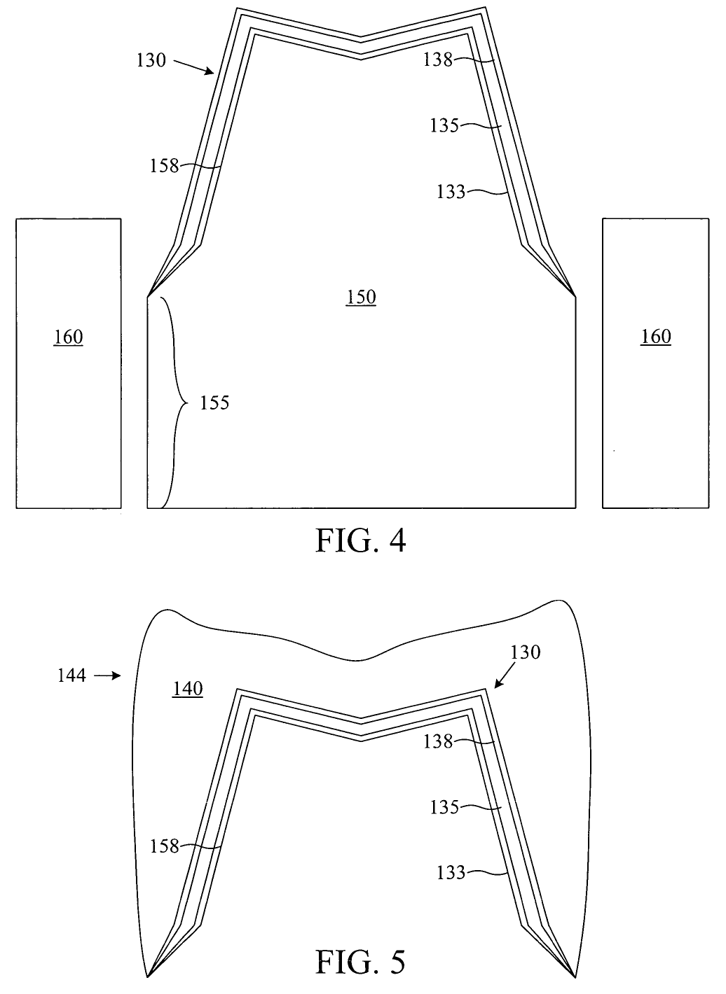

FIG. 4 is a cross-sectional view of a substrate mandrel 150 upon which a three-layer coping 130 has been formed. As described above, the mandrel 150 may for example be a die stone that has been formed from an impression of the tooth stub, not shown in this figure. The mandrel 150 may consist of common dental ceramic or polymer mold materials that are vacuum compatible. Various methods of forming a die stone replicating the desired tooth shape are known and used by dental laboratories. Other mandrel fabrication methods and materials consisting of metals such as aluminum, copper, stainless steel, epoxy, polyamide or other polymer materials can be used. The mandrel 150 may also be formed by scanning a die stone and then using the digital information from the scan in a CAD/CAM method to machine a block of material to form the mandrel 150. The digital information from the scan may be transmitted electronically to a dental laboratory, thereby avoiding the trouble and expense of shipping the die stone to the laboratory.

The coping 130 has been formed by physical vapor deposition, such as cathodic arc deposition, sputtering, ion beam deposition, molecular beam deposition, etc. An inner layer 133 of the coping is formed of TiN, a middle layer 135 of the coping is formed of Ti, and an outer layer of the coping is formed of TiN in this embodiment. Other metals and their ceramic oxides, nitrides or oxynitrides may be employed in other embodiments. The middle layer 135 is typically thicker than both the inner layer 133 and the outer layer 138. A porcelain layer 140 has been formed on and bonded to the coping to form a crown 144. The mandrel 150 in this embodiment has a handle portion 155 that is substantially flush with the largest portion of the positive mold 158 of the tooth stub, upon which the coping 130 is formed. The tooth stub mold 158 has tapered sides and a tapered flange at a base that meets the handle 150. The coping layers 133, 135 and 138 each have a tapered thickness adjacent to the base, which may be created by a shadow during PVD. The tapered portion of layers 133, 135 and 138 extends about 0.05 mm to 2.0 mm. The tapered thickness of the coping layers may also be created by a metal finishing process that is performed after the deposition of the middle layer 135 and before the deposition of the outer layer 138.

The inner layer 133 of TiN may have a thickness ranging between about 1000 Å and 50 μm, the middle layer 135 of Ti metal may have a thickness ranging between about 0.005 mm and 10 mm, and the outer layer 138 of TiN may have a thickness ranging between about 1000 Å and 50 μm. The inner layer 133 provides the bonding interface between the coping layers 130 and the cementing layer bonding the coping to the tooth. The inner layer 133 may include vapor-deposited titanium-nitride, oxynitride or zirconium nitride, oxide or oxy-nitride. These materials exhibit a yellow gold like optical reflective quality that may be preferred under a translucent cement layer and tooth dentin and enamel. Titanium oxide, which is black, may instead form the inner layer 133. The outer layer 138 may include vapor-deposited titanium-nitride, titanium oxynitride, zirconium nitride, zirconium or zirconium oxy-nitride. These materials exhibit a yellow gold like optical reflective quality that may be preferred under a translucent cement layer and tooth dentin and enamel. Zirconium oxide, which is white, may instead form the outer layer 138.

Some embodiments include an optional gold layer underlying the porcelain layer 140. In such embodiments, the ceramic outer layer 138 serves as a diffusion barrier that prevents diffusion of gold atoms into the middle layer 135. A ceramic outer layer 138 that functions as a diffusion barrier may include nitrides, oxides or oxynitrides of titanium, silicon, zirconium or hafnium. Alternatively, the outer ceramic outer layer may be an oxide, nitride or oxynitride of cobalt and/or nickel alloys described above, such as a CoCrMo oxide.

The mandrel 150 material can be removed from the deposited layers which form the dental coping 130. Typical dental ceramic mandrel material may be removed with a small hand grinder and then grit blasted or chemical etched in a basic pH solution to remove the remaining mandrel residual material. Such hand grinder and grit blasting techniques are known in the dental laboratories. The basic solution consists of a KOH or NaOH solution with a PH ranging from 8-14. High-pressure steam cleaning or steamer and water in an ultrasonic bath are a method of removing the residual mandrel material.

Typical dental porcelain layers can then be applied and sintered onto the outer layer 138, yielding a porcelain fused to metal (PFM) crown shown in FIG. 5. The dental porcelain materials and firing or baking process can be those known and used in dental laboratories. Instead of porcelain layer 140, such a crown can be made from all metal and/or ceramic layers that have been formed by physical vapor deposition. For example, such a crown could be made of the coping layers 133, 135 and 138 described above, followed by a layer of ceramic such as zirconium-dioxide (ZrO2), which is white in color and can be polished as desired. Porcelain or ceramic tooth veneers can be similarly formed.

Alternatively, the mandrel 150 material such as gypsum can be removed after the porcelain layer 138 or layers have been formed on the coping. This can be particularly advantageous for the situation in which a very thin coping 130 is desired, e.g., a coping thickness less than 0.2 mm. In this case, stress from the porcelain as it hardens could alter the coping shape. In the prior art this problem has not been encountered because such a thin coping could not be produced. After the porcelain has been sintered the mandrel material is removed by grinding and optional etching. In this situation it is desirable to use an etchant, such as HNO₃ HCL H₂SO₄ NaOH or KOH, that does not react with porcelain.

It is preferable that the mandrel 150 be slightly larger than the tooth stub so that the completed coping formed on the mandrel 150 fits easily over the tooth stub when the crown including the coping is later installed by a dentist. Preferably there is a separation of about 20 microns between the interior surface of the coping and the exterior surface of the tooth stub. There are several ways to form a mandrel 150 or die stone that is slightly larger than the tooth stub.

One way to make a die stone that is slightly enlarged relative to the tooth stub is to make the die stone from a refractory die material that expands at high temperature. The refractory die material is poured into a mold and allowed to set to form the die stone. The die stone is later exposed to high temperature (1000 to 2000 degrees centigrade or higher) during a step such as burning out wax or firing porcelain. At high temperature the die stone expands, so that a coping or an all-ceramic crown formed on the expanded die stone has internal dimensions that are slightly enlarged relative to the dimensions of the tooth stub.

When a coping is formed by PVD using a method in accordance with an embodiment of this invention, the die stone is not exposed to high temperature before or during the PVD process. In such a method, the coping is formed at temperatures less than 400 degrees centigrade. While the coping will later be exposed to high temperature to fire the porcelain layer, the coping size is already determined before that porcelain firing step. It is desirable to enlarge the die stone without relying upon thermal expansion of the refractory material used to form the die stone.

Another way to make a die stone that is slightly enlarged relative to the tooth stub is to increase the setting expansion of the refractory die material from which the die stone is formed. The die stone is formed by pouring a slurry of refractory die material into a mold and allowing it to set. During the setting process, the refractory die material expands somewhat. The applicants have found that combining a particular refractory die material and a particular liquid increases the setting expansion of the refractory material. The refractory die material is Polyvest, which is available from Whip Mix Corporation, P.O. Box 17183, Louisville, Ky. 40217. The liquid that is combined with the refractory die material is a colloidal silica suspension called Begosol™ which is available from BEGO U.S.A Inc., 2091 Bion Rd., Lincoln, R.I. 02865.

The setting expansion of refractory die materials is non-uniform. The material expands more in regions where the material is not constrained, such as the open end of a mold. This non-uniform setting expansion is undesirable, so it is preferable not to rely entirely upon setting expansion for producing a die stone that is enlarged relative to the tooth stub.

The applicants have found that the die stone can be further enlarged by using thermal expansion to enlarge the silicone mold in which the die stone is formed. The mold for the die stone is made from silicone that has a thermal expansion of about 200×10⁻⁶(mK⁻¹⁾/m). The silicon mold is formed upon the original die received from a dentist. After the silicone mold has cured, the silicone mold is heated in an oven to 62 degrees centigrade which causes about 0.05 percent expansion of the silicone mold. The refractory die material combination described previously is poured into the heated silicone mold and allowed to set. The thermal expansion of the silicone mold together with the increased setting expansion of the refractory die material combination yields a die stone having dimensions which are slightly enlarged relative to the tooth stub. The silicone material used to form the mold is Wirosil™ which is available from BEGO U.S.A Inc., 2091 Bion Rd., Lincoln, R.I. 02865.

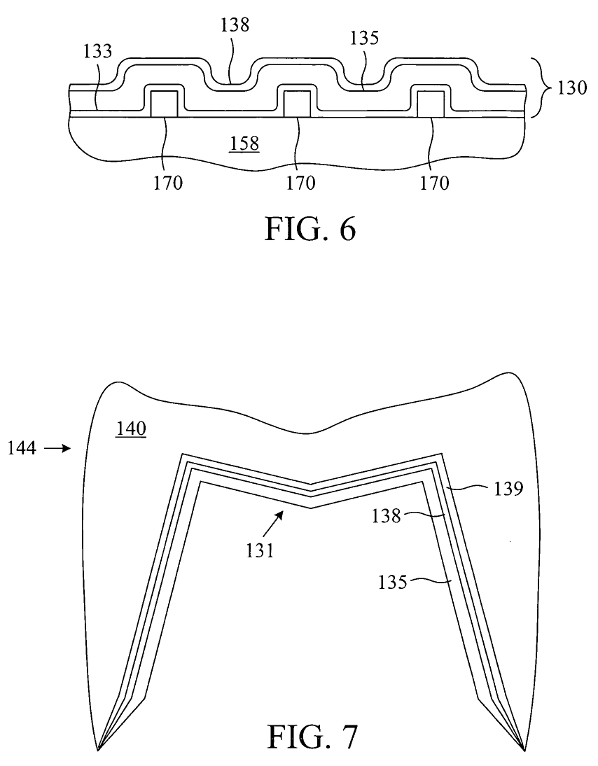

FIG. 6 is a cross-sectional view of a portion of the tooth mold 158 with a plurality of attached protrusions 170 that affect the texture of the coping 130. The protrusions 170 in this embodiment have a generally rectangular cross-sectional shape, but other protrusions having cross-sectional shapes such as circular, oblong, oval, triangular, or irregular may instead be employed. The coping layers 133, 135 and 138 replicate the mandrel mold 158 with the residing protrusions 170. The protrusions 170 have widths and heights that typically range between about 0.5 μm and 1.0 mm. The substrate mandrel is removed leaving the dental coping shell 130 with pockets that replicate the protrusions. The substrate mandrel and formed substrate protrusions, which may be made of the same or different materials, may be removed from the shell 130 by the same method as described earlier.

Further details of an embodiment like that shown in FIG. 1 are described below. In one aspect the device comprises a titanium/titanium-nitride based laminate intended for use as a base metal alloy in the making of single unit device porcelain-fused-to-metal (PFM) prosthetic dental materials and custom-made dental prosthetic devices, such as a porcelain-to-metal veneer for a tooth. Such a device can be a single unit coping device, i.e., a PFM dental restorative device that may be used for all anterior and posterior tooth dental crown restorations.

The device may be manufactured by a dental laboratory to the prescribed dimensions and fit instructed by a dentist, in accordance with an impression made by the dentist. The device can be formed of unalloyed Ti metal (Grade 2) deposited by cathodic arc deposition onto a suitable dental stone positive mold replica of the desired tooth shape, from the impression, to be fitted with a dental coping sub-structure. The cathodic arc deposition includes a Ti cathode material, metal plasma in vacuum, sustained by a guided plasma arc on the cathode surface. The mold is rotated at a predetermined angle in a vacuum environment while Ti metal is deposited onto the mold. The deposited Ti material forming the dental coping structure is accomplished by transporting the Ti metal vapor from the Ti plasma originating from the unalloyed Ti cathode to the rotating ceramic mold. The deposited Ti metal thickness forming the dental coping wall thickness is controlled by the total deposition time Ti_{(dep)} (min.) calculated from the known deposition rate Ti₍ᵣₐₜₑ₎ (μm/min.) of the Cathodic Arc Source and the targeted wall thickness Ti_{(wall)} (μm) of the titanium dental coping. That is,
Ti_{(dep)}(min.)=[Ti_{(wall)}(μm)]/[Ti₍ᵣₐₜₑ₎(μm/min.)].

Typical Ti wall thickness ranges from 100 μm-350 μm. The dental coping wall thickness can made to the thickness desired by the dental laboratory. The second layer forming the exterior of the dental coping consists of TiN, deposited directly after the Ti layer without interrupting the deposition process or vacuum environment. The TiN layer is formed by the addition of high purity nitrogen gas (99.99% purity), into the Ti metal plasma under vacuum. The nitrogen gas reacts with the Ti plasma and forms the TiN chemical compound on the Ti surface. The overall atomic concentration of Ti in the TiN layer may range between about 45% and 55%, and the overall atomic concentration of N in the TiN layer may also range between about 45% and 55%. The TiN layer forms the exterior surface of the dental coping and bonds to the porcelain veneer material. Typical TiN thickness is in a range between about 10 μm and 20 μm.

After the Ti metal and TiN layers are deposited, the mold material can be removed by using tools typically used by dental laboratories. The bulk of the mold material can be removed by hand grinding, followed by abrasive alumina grit blasting. The final Ti/TiN dental coping fit can be adjusted by hand grinding until the proper fit to master mold is obtained. The dental porcelain can be applied to the exterior TiN layer by the dental laboratory. Vita Titanium Porcelain, available from Vident Corporation, 3150 East Birch Street, Brea, Calif. 92821, is one type of porcelain that has been used with success. A dentist can fit and cement the finished PFM crown onto the prepared tooth.

Table 1 lists some specifications of this embodiment, in which LSL refers to a lower specification limit, and USL refers to an upper specification limit.

TABLE 1

| DESCRIPTION | NOMINAL | TOLERANCE |
|---|---|---|
| Titanium | Titanium | Titanium Grade 2 |
| Cathode | Grade 2 | |
| Composition. | | |
| Deposited | Titanium | Titanium Grade 2 |
| Titanium | Grade 2 | |
| Dental coping | | |
| composition. | | |
| Deposited | Ti.₅₀N.₅₀ | USL = Ti.₄₅N.₅₅ |
| Titanium- | (atomic | USL = Ti.₅₅N.₄₅ |
| nitride | concentration) | |
| Composition. | | |
| Dental coping | As | USL = +10% OF |
| wall | specified | AVG. |
| thickness | by Dental | LSL = −10% OF |
| Titanium | Laboratory, | AVG. |
| metal 100 μm-350 μm. | end-user. | |
| Dental coping | 10 μm | LSL = 5 μm |
| wall | | USL = 20 μm |
| thickness | | |
| Titanium- | | |
| nitride. | | |
| Density | 4.74 gm/cm³ | LSL = 4.24 gm/cm³ |
| | | USL = 5.24 gm/cm³ |
| Proof Stress | 265 Mpa | LSL = 250 MPa |
| | | USL = 300 MPa |
| Modulus | 61 GPa | LSL = 50 GPa |
| | | USL = 100 GPa |
| Elongation | 8.5% | LSL = 3% |
| | | USL = 20% |
| Coeff. Of | 8.8 × 10⁻⁶ K⁻¹ | LSL = 8.3 × 10⁻⁶ K⁻¹ |
| Exp. | | USL = 9.3 × 10⁻⁶ K⁻¹ |
| 25-500° C. | | |
| Porcelain | 35 Mpa | LSL > 25 MPa |
| Bond | | USL = 100 MPa |

Table 2 provides a chemical analysis of some Ti sample layers that were cathodic arc deposited on a silicon wafer.

TABLE 2

| | Ti Coping Layer |
|---|---|
| ELEMENT | Maximum Values Wt. % |
| Nitrogen, max. | .006 |
| Carbon, max | .013 |
| Hydrogen, max | .0012 |
| Iron, max | .06 |
| Oxygen, max. | .069 |
| Aluminum | .01 |
| Vanadium | .0033 |
| Tin | .0042 |
| Ruthenium | <.00001 |
| Palladium | <.00005 |
| Cobalt | .00016 |
| Molybdenum | .0013 |
| Chromium | .0130 |
| Nickel | .0058 |
| Niobium | .00044 |
| Zirconium | .0015 |
| Silicon | .0015 |
| Residuals, max. each | .06 |
| Residuals, max., total | .145 |
| Titanium, balance | 99.77 |

Table 3 provides a chemical analysis of some 10 μm-20 μm thick TiN sample layers that were cathodic arc deposited on 100 μm-200 μm thick Ti layers.

TABLE 3

| SAMPLE | Ti (at. %) | N (at. %) |
|---|---|---|
| 1 | 52.0 | 48.0 |
| 2 | 53.0 | 47.0 |
| MEAN | 52.5 | 47.5 |

The mean composition of two TiN samples consist of titanium 52.5% and nitrogen 47.5% (atomic percent), +/−5% uncertainty, as measured by Rutherford Backscatter Analysis. Stoichiometric TiN is Titanium 50% and Nitrogen 50. The measured TiN composition of the Nano-TiCrown™ is equivalent to stoichiometric TiN compound. The Ti/TiN porcelain fused to metal crowns have also been successfully tested for metal-ceramic bond strength requirements, thermal expansion coefficient (CTE) requirements, and biocompatibility requirements.

As illustrated in FIG. 4, a coping 130 of a crown 144 is tapered at its lower edge so that it will merge smoothly with the tapered stub of a tooth, with no appreciable ledge or discontinuity at the junction between crown and tooth. The coping may be tapered either by shadowing during PVD or by a metal finishing process that is performed after the deposition of the metallic structural layer (middle layer) and before the deposition of the ceramic outer layer.

If the metal finishing process is used for tapering, the metallic structural layer can be deposited as described previously. Optionally, a TiN layer about 20 μm thick can be deposited over the structural layer to protect against contaminants during the metal finishing process. The vacuum can then be broken on the PVD system, and the mandrel with the partially formed coping attached can be removed from the PVD system. The mandrel material can be removed by methods such as hand grinding or abrasive alumina grit blasting.

Next, a residual flashing can be removed from the lower edge of the partially formed coping, and an area adjacent to and including the lower edge of the coping can be tapered by hand using a grinding instrument. The tapered area may extend upwards as much as 2 mm above the lower edge of the coping. The grinding process removes from the tapered area the TiN layer which was optionally included to protect against contaminants. The remainder of the optional TiN layer can be removed by abrasive alumina grit blasting, which also creates a roughened texture on the surface of the coping. The partially formed coping, now tapered and roughened, can be cleaned with steam and then cleaned with alcohol.

The partially formed coping can be returned to the PVD system and subjected to a sputter etch or an ion etch in order to remove from the coping surface any residual TiN and any organic contaminants that may be present; the etching process also removes a very thin layer of metal from the coping surface. Upon the clean metal surface a very thin layer of metal can be deposited. The deposited metal is the same as the metal that was used in the original deposition of the structural layer, and the thickness of the deposition is approximately 100-300 angstroms. This thin metal layer, which is part of the metallic structural layer of the coping, is part of a substrate on which the ceramic outer layer will be deposited. Deposition of the ceramic outer layer can be performed as described previously.

FIG. 7 depicts an embodiment of the invention which is a dental device. The dental device, which in this embodiment is a crown 144, includes a coping 131. The coping 131 is a metal-ceramic laminate that includes a metallic structural layer 135 that provides most of the strength of the laminate and a ceramic outer layer 138. The structural layer 135 is relatively thick and can serve as a self-supporting substrate upon which further layers may be applied. The ceramic layer 138 is thinner than the metallic structural layer 135. A porcelain layer 140 is attached to the ceramic layer 138. The porcelain layer 140 is thicker than the ceramic layer 138. An optional gold layer 139 may be included between the ceramic layer 138 and the porcelain layer 140. When the gold layer 139 is included, the porcelain layer 140 is attached indirectly to the ceramic layer 138 through bonding of the porcelain layer 140 to the gold layer 139. The gold layer 139 thickness can range between 0.5 microns to 50 microns. Relative to the ceramic layer 138, the gold layer can be thinner or up to about five times thicker.

The structural layer 135 may be formed by PVD using methods described previously and may include any of the metals or metal alloys that were previously listed as suitable for use in the deposited layers. The structural layer 135 may be doped with 0.1 to 2 atomic percent nitrogen or oxygen. As described previously, doping can stabilize the crystalline phase of a metal, so that the crystalline phase is stable throughout the range of temperatures to which the coping 131 is exposed during fabrication of the dental device. The metals which may be doped include titanium, zirconium, molybdenum, tungsten, tantalum, niobium, vanadium, chromium, nickel, hafnium, aluminum, cobalt and alloys of these metals.

The structural layer 135 may include cobalt or cobalt alloys. Cobalt and cobalt alloys can be advantageous for biomedical embodiments because certain cobalt alloys are known to have high strength and to be biocompatible with mammals. A preferred material for the structural layer 135 is cobalt chromium molybdenum (CoCrMo) in which the chromium and molybdenum are at least partially oxydized. CoCrMo is advantageous for dental devices because its coefficient of expansion matches that of dental porcelains commonly used. One CoCrMo alloy that has been used with success is Vitallium™ which includes approximately 62 percent cobalt, 29 percent chromium, and 6.5 percent molybdenum, the balance consisting of impurities. Vitallium™ is available from Kalco Metals, Inc., 650 Broadway Avenue, Farrell, Pa. 16121. Suitable cobalt alloys include 20 to 90 atomic percent cobalt and 10 to 80 atomic percent chromium or molybdenum or titanium or combinations of those metals. Oxides of chromium, molybdenum or titanium provide biocompatibility.

A structural layer 135 made of CoCrMo may be formed by PVD using methods described previously and using the deposition system shown in FIG. 3. PVD is advantageous for forming devices made of CoCrMo, in contrast to casting methods which are somewhat difficult to use with CoCrMo. In one PVD method, there is a single target 102 made of CoCrMo. Alternatively, there can be several targets 102: a cobalt target, a chromium target, and a molybdenum target, affording the possibility of greater variation in the composition of the CoCrMo. If several targets 102 are used, the several target 102 sources can converge at one mandrel 50 with simultaneous deposition of the three metals. Alternatively, a platter 105 can move past the several targets 102 sequentially, with alternating deposition of monolayers of each metal upon the mandrel 50. Such a device can also comprise

Instead of forming a self-supporting substrate by PVD as described above, a metallic substrate can be provided, upon which ceramic and porcelain layers are formed, with a gold layer optionally formed between the ceramic and porcelain layers. For example, a titanium denture framework can be provided, upon which is formed a PVD ceramic layer, a gold layer and a porcelain coating to create a denture. Similarly, metallic copings formed by CAD/CAM can be provided which are coated by a vapor-deposited ceramic layer, porcelain and an optional gold interlayer.

The ceramic layer 138 can serve several functions. As noted previously, the ceramic layer 138 provides a good bonding surface for the porcelain layer 140, and a ceramic layer 138 may have a color which is aesthetically advantageous for use beneath a translucent porcelain layer 140. In embodiments that include a gold layer 139, the ceramic layer 138 may serve as a diffusion barrier that prevents diffusion of gold atoms into the structural layer 135. The ceramic layer 138 may be formed by PVD using methods described previously.

A ceramic layer 138 that functions as a diffusion barrier may include nitrides, oxides or oxynitrides of titanium, silicon, zirconium or hafnium. Nitrides are preferable because they are easier to work with. As with any ceramic layer 138 formed by PVD, the atomic composition of the layer need not include stoichiometric ratios of elements. Titanium silicon nitride may be used as a diffusion barrier for gold. One suitable composition includes 27 atomic percent titanium, 20 atomic percent silicon, and 53 atomic percent nitrogen, but other compositions may also be used.

An optional gold layer 139 may be included beneath the porcelain layer 140 of the embodiment shown in FIG. 7. Inclusion of a gold layer may be advantageous because gold provides biocompatibility and a color that is aesthetically satisfactory beneath the porcelain layer 140. To maximize biocompatibility, the gold layer 139 preferably includes a very high fraction of gold with only minor amounts of other elements. High-purity gold is soft, so it is advantageous to apply a thin gold layer 139 over a relatively strong self-supporting substrate such as the metallic structural layer 135. A thin gold layer 139 is also preferable because gold is expensive. The gold layer 139 preferably has a thickness of 1 μm to 20 μm, and a typical thickness is 5 μm.

If a thin gold layer 139 is applied directly over a metallic structural layer 135, the small mass of gold may diffuse into the metallic structural layer 135 during subsequent high-temperature processing, resulting in the obliteration of the separate gold layer 139. To prevent diffusion of gold atoms into the metallic structural layer 135, a ceramic layer 138 can be included between the metallic structural layer 135 and the gold layer 139. The ceramic layer 138 serves as a diffusion barrier that prevents gold atoms from migrating out of the gold layer 139.

A gold layer 139 preferably includes a small fraction of other metals which form oxides or nitrides that bond well to the porcelain layer 140. In one embodiment, the gold layer 139 includes at least 95 atomic percent of gold and between 0 and 5 atomic percent of indium, zinc, tin, titanium, zirconium, niobium, tantalum, hafnium, platinum, palladium or silver, and between 0.1 and 10.0 atomic percent of oxygen or nitrogen. One gold alloy that has been used successfully in a gold layer 139 is described in U.S. Pat. No. 5,922,276 and is available from The Argen Corporation, 5855 Oberlin Drive, San Diego, Calif. 92121-4718. minor constituent metals form an oxide that binds to porcelain; oxides provide bonding, gold provides aesthetics and biocompatibility. Pure gold will not bond well to conventional porcelain layers since there are no metal oxides present. For the case in which a pure gold layer is used, a special intermediate porcelain adhesion layer may be applied prior to the first opaque porcelain layer.

In a preferred embodiment, the gold layer 139 comprises a nanocomposite of gold and oxides, nitrides or oxynitrides of indium, tin or zinc. The indium, tin and zinc total less than 2 atomic percent of the nanocomposite. The nanocomposite may be formed by PVD using methods described previously, and the deposition occurs in the presence of oxygen or nitrogen. The gold layer 139 can be deposited over the ceramic layer 138, and a vacuum break may occur after deposition of the ceramic layer 138. The ceramic layer 138 can be first etched lightly by a sputter etch or ion etch, and then the gold nanocomposite can be deposited by sputter etch or ion etch after a change in voltage. The deposition vapor includes both atomic vapor and molten droplets, and the deposited nanocomposite can have a deposited ratio of (atomic vapor)/(molten droplets) and preferably greater than about 1.0. The oxides of indium, tin or zinc are distributed throughout the nanocomposite layer as a result of the forming of the layer by PVD.

A ceramic layer 138 that is used as a diffusion barrier may have a thickness of 1 μm to 30 μm. The ceramic layer 138 preferably is of sufficient thickness to block migration of gold atoms during high-temperature processing, and the thickness that is sufficient depends at least in part upon the temperature to which the ceramic layer 138 is exposed. Various porcelains are used in dental devices, and the firing temperatures of commonly used porcelains range from 500 degrees centigrade to 2000 degrees centigrade. For a firing temperature of about 900 degrees centigrade, a thickness of 10 μm is sufficient to block diffusion of gold atoms.

The gold layer 139 may be formed by methods other than PVD. The gold layer 139 may be formed by electroplating of gold onto the coping 131. The gold layer 139 may be formed by applying a slurry of gold particles suspended in a polymer base over the coping 131 and then firing the partially-formed device to fuse the gold particles. The gold layer 139 may be formed using a gold foil product called Captek™ which is pressed over a coping and then fired. Captek™ is available from The Precious Chemicals Company Inc., 250 Altamonte Commerce Boulevard, Altamonte Springs, Fla. 32714. The ceramic layer 138 may be used as a diffusion barrier with a gold layer 139 that is formed by a method other than PVD.

A ceramic layer 138 that is used as a diffusion barrier may be deposited over a substructure that includes alumina, zirconia, or other ceramic materials, as an alternative to depositing the ceramic layer 138 directly onto a metallic structural layer 135.

The porcelain layer 140 may be applied using methods and materials described previously. The porcelain layer 140 may also be applied using the press-to-metal technique. In the press-to-metal technique, molten porcelain is forced into a cavity in a mold surrounding the coping 131, the porcelain is allowed to cool, and the device is fired.

Although the above description has focused on illustrating exemplary PVD biomedical devices and methods, other devices and methods can be formed in accordance with the teachings of this disclosure. Moreover, other embodiments and modifications of this disclosure will be apparent to persons of ordinary skill in the art in view of these teachings. Therefore, the methods and devices taught in this invention are not limited, and can be applied to other biomedical devices, electronic and optical devices.

1. A dental device comprising:
a metal-ceramic laminate including a metallic structural layer that provides most of the strength of the laminate and a ceramic outer layer having a thickness that is less than that of the structural layer, the ceramic outer layer made of a nitride, oxide or oxynitride of titanium (Ti) or zirconium (Zr); and
a porcelain layer that is attached to the ceramic outer layer, the porcelain layer having a porcelain layer thickness that is greater than the ceramic outer layer thickness.

2. The device of claim 1, wherein the structural layer is made of a metal doped with 0.1 to 2 atomic percent nitrogen (N) or oxygen (O).

3. The device of claim 1, wherein the structural layer has a crystalline phase, the crystalline phase being stable between 20 and 1200 degrees centigrade.

4. The device of claim 1, wherein the structural layer is made of cobalt chromium molybdenum (CoCrMo).

5. The device of claim 4, wherein the cobalt chromium molybdenum (CoCrMo) is doped with 0.1 to 2 atomic percent nitrogen (N) or oxygen (O).

6. The device of claim 1, wherein the structural layer comprises a cobalt (Co) alloy layer including at least 20 atomic percent cobalt (Co) and at least 10 atomic percent chromium (Cr) or molybdenum (Mo) or titanium (Ti) and 0.1 to 5 atomic percent oxygen (O).

7. The device of claim 1, wherein the structural layer includes a cobalt (Co) alloy having a coefficient of expansion substantially matching that of the porcelain layer.

8. The device of claim 1, further comprising a gold layer disposed between the ceramic outer layer and the porcelain layer.

9. The device of claim 8, wherein the gold layer comprises a nanocomposite of gold (Au) and oxides, nitrides or oxynitrides of indium (In), tin (Sn) or zinc (Zn).

10. The device of claim 8, wherein the gold layer includes at least 95 atomic percent of gold (Au), between 0.1 and 10 atomic percent of oxygen (O) or nitrogen (N), and between 0.1 and 5 atomic percent of at least one metal selected from the group consisting of indium (In), zinc (Zn), tin (Sn), titanium (Ti), zirconium (Zr), niobium (Nb), tantalum (Ta), hafnium (Hf), platinum (Pt), palladium (Pd), silver (Ag), aluminum (Al), silicon (Si) and chromium (Cr).

11. A method for producing a dental device comprising:
providing a metallic substrate for the dental device;
forming by physical vapor deposition (PVD) a ceramic outer layer on the metallic substrate, the ceramic outer layer made of a metal nitride, oxide or oxynitride; and
forming a porcelain layer atop the ceramic outer layer.

12. The method of claim 11, wherein providing the metallic substrate includes forming the substrate by PVD.

13. The method of claim 12, wherein forming the substrate includes doping the substrate with oxygen or nitrogen.

14. The method of claim 11, wherein providing the metallic substrate includes forming a cobalt (Co) alloy.

15. The method of claim 11, further comprising forming a gold layer over the ceramic outer layer, prior to forming the porcelain layer.

16. The method of claim 15, wherein forming a gold layer over the ceramic outer layer comprises forming a nanocomposite of gold (Au) and oxides, nitrides or oxynitrides of indium (In), tin (Sn) or zinc (Zn).

17. A dental device comprising:
a self-supporting substrate made of a cobalt (Co) or nickel (Ni) alloy having a first coefficient of expansion;
a ceramic layer attached to the substrate, the ceramic layer made of a nitride, oxide or oxynitride of titanium (Ti), zirconium (Zr) or hafnium (Hf); and
a porcelain layer attached to the ceramic layer, the porcelain layer having a porcelain layer thickness that is greater than the ceramic layer thickness, the porcelain layer having a second coefficient of expansion, wherein the first coefficient of expansion substantially matches the second coefficient of expansion.

18. The device of claim 17, wherein the alloy comprises cobalt chromium molybdenum (CoCrMo).

19. The device of claim 18, wherein the cobalt chromium molybdenum (CoCrMo) is doped with 0.1 to 2 atomic percent nitrogen (N) or oxygen (O).

20. The device of claim 17, wherein the substrate has a thickness that is greater than that of the ceramic layer.

21. The device of claim 17, wherein the substrate includes at least 20 atomic percent cobalt (Co) and at least 10 atomic percent of chromium (Cr) or molybdenum (Mo) or titanium (Ti) and 0.1 to 5 atomic percent oxygen (O).

22. A dental device comprising:
a self-supporting substrate;
a ceramic outer layer attached to the self-supporting substrate, the ceramic outer layer having a thickness that is less than that of the self-supporting substrate, the ceramic outer layer made of a nitride, oxide or oxynitride of titanium (Ti), silicon (Si), zirconium (Zr) or hafnium (Hf);
a gold layer attached to the ceramic outer layer; and
a porcelain layer attached to the gold layer, the porcelain layer having a porcelain layer thickness that is greater than the ceramic outer layer thickness.

23. The device of claim 22, wherein the gold layer comprises a nanocomposite of gold (Au) and oxides, nitrides or oxynitrides of indium (In), tin (Sn) or zinc (Zn).

24. The device of claim 22, wherein the gold layer includes at least 95 atomic percent of gold (Au), between 0.1 and 10 atomic percent of oxygen (O) or nitrogen (N), and between 0.1 and 5 atomic percent of at least one metal selected from the group consisting of indium (In), zinc (Zn), tin (Sn), titanium (Ti), zirconium (Zr), niobium (Nb), tantalum (Ta), hafnium (Hf), platinum (Pt), palladium (Pd), silver (Ag), aluminum (Al), silicon (Si) and chromium (Cr).
